(19) United States
(12) Patent Application Publication
(10) Pub. No.: US 2019/0347239 A1
(43) Pub. Date: Nov. 14, 2019

(54) GENERALIZED CONFIGURABLE TRIGGER

(71) Applicant: QUALCOMM Incorporated, San Diego, CA (US)

(72) Inventors: Lalan Jee MISHRA, San Diego, CA (US); Richard Dominic WIETFELDT, San Diego, CA (US); Helena Deirdre O'SHEA, San Diego, CA (US)

(21) Appl. No.: 16/400,447

(22) Filed: May 1, 2019

Related U.S. Application Data
(60) Provisional application No. 62/670,663, filed on May 11, 2018.

(51) Int. Cl. G06F 13/42; G06F 13/24; G06F 9/30

(52) U.S. Cl. CPC G06F 13/4291; G06F 9/30138; G06F 13/24

(57) ABSTRACT

A device for activating trigger data has a serial bus interface and a processing circuit coupled to the serial bus interface. The processing circuit is configured to receive a plurality of trigger data via a serial bus, receive a plurality of activation data via the serial bus, detect an activation scheme for activating a respective trigger data of the plurality of trigger data based on activation data corresponding to the respective trigger data, and activate the respective trigger data according to the detected activation scheme. If activated, each one of the plurality of trigger data respectively enables a corresponding operation to be performed at the device. Each one of the plurality of activation data respectively correspond to each one of the plurality of trigger data.

### PRIORITY CLAIM

This application claims priority to and the benefit of U.S. Provisional Patent Application Ser. No. 62/670,663 filed in the U.S. Patent Office on May 11, 2018, the entire content of this application being incorporated herein by reference as if fully set forth below in its entirety and for all applicable purposes.

### TECHNICAL FIELD

The present disclosure relates generally to communication devices, and more particularly, to communications links connecting integrated circuit devices within an apparatus.

### BACKGROUND

Serial interfaces have become the preferred method for digital communication between integrated circuit (IC) devices in various apparatus. For example, mobile communications equipment may perform certain functions and provide capabilities using IC devices that include radio frequency transceivers, cameras, display systems, user interfaces, controllers, storage, and the like. General-purpose serial interfaces known in the industry, including the Inter-Integrated Circuit (I2C or I²C) serial bus and its derivatives and alternatives, including interfaces defined by the Mobile Industry Processor Interface (MIPI) Alliance, such as I3C and the Radio Frequency Front End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front end devices, including power amplifier (PA), low-noise amplifiers (LNAs), antenna tuners, filters, sensors, power management devices, switches, etc. These devices may be collocated in a single integrated circuit (IC) or provided in multiple IC devices. In a mobile communications device, multiple antennas and radio transceivers may support multiple concurrent RF links. Certain functions can be shared among the front end devices and the RFFE interface enables concurrent and/or parallel operation of transceivers using multi-master, multi-slave configurations.

As the demand for improved communications between devices continues to increase, there exists a need for improvements in protocols and methods for managing the interfaces between RF front end devices.

### SUMMARY

Certain aspects of the disclosure relate to systems, apparatus, methods and techniques that can facilitate communicating and activating triggers through datagrams transmitted over a serial bus.

In various aspects of the disclosure, a method performed at a device for activating trigger data includes receiving a plurality of trigger data via a serial bus, receiving a plurality of activation data via the serial bus, detecting an activation scheme for activating a respective trigger data of the plurality of trigger data based on activation data corresponding to the respective trigger data, and activating the respective trigger data according to the detected activation scheme. If activated, each one of the plurality of trigger data respectively enables a corresponding operation to be performed at the device. Each one of the plurality of activation data respectively corresponds to each one of the plurality of trigger data. The plurality of trigger data and the plurality of activation data are received via a single datagram.

In certain aspects, the received plurality of trigger data and the received plurality of activation data are stored in contiguous register locations of a register space. Each one of the received plurality of trigger data may be stored in an alternating manner with a corresponding one of the received plurality of activation data in the register space. The activation scheme may be detected by reading a mode bit of the corresponding activation data, detecting that the respective trigger data is to be activated according to a countdown if the mode bit is a first value, and detecting that the respective trigger data is to be activated according to a command if the mode bit is a second value. If the mode bit is the first value, the respective trigger data may be activated by retrieving a countdown value from the corresponding activation data, selecting a clock source for the countdown, operating the countdown based on the clock source beginning from the countdown value, and activating the respective trigger data when the countdown reaches a value of 0. The clock source may be selected based on a received datagram addressed to a clock source selection register. The clock source can be a local clock or a bus clock. If the clock source is the bus clock, the operating the countdown includes at least one of compensating for a missed bus clock cycle using the local clock, or using the bus clock when the serial bus is an interrupt-monitoring phase. If the mode bit is the second value, the activating the respective trigger data includes receiving a trigger command for activating the respective trigger data via at least one of a datagram addressed to a command activated command register or a correlated signal from the serial bus, and activating the respective trigger data based on the trigger command.

In various aspects of the disclosure, a device for activating trigger data has a serial bus interface and a processing circuit coupled to the serial bus interface. The processing circuit is configured to receive a plurality of trigger data via a serial bus, receive a plurality of activation data via the serial bus, detect an activation scheme for activating a respective trigger data of the plurality of trigger data based on activation data corresponding to the respective trigger data, and activate the respective trigger data according to the detected activation scheme. If activated, each one of the plurality of trigger data respectively enables a corresponding operation to be performed at the device. Each one of the plurality of activation data respectively correspond to each one of the plurality of trigger data.

In various aspects of the disclosure, a device for activating trigger data, includes means for receiving a plurality of trigger data via a serial bus, means for receiving a plurality of activation data via the serial bus, means for detecting an activation scheme for activating a respective trigger data of the plurality of trigger data based on activation data corresponding to the respective trigger data, and means for activating the respective trigger data according to the detected activation scheme. If activated, each one of the plurality of trigger data respectively enables a corresponding operation to be performed at the device. Each one of the plurality of activation data respectively corresponds to each one of the plurality of trigger data.

In various aspects of the disclosure, a processor-readable storage medium has one or more instructions which, when executed by at least one processor or state machine of a processing circuit for activating trigger data at a device, cause the processing circuit to receive a plurality of trigger data via a serial bus, receive a plurality of activation data via the serial bus, detect an activation scheme for activating a respective trigger data of the plurality of trigger data based on activation data corresponding to the respective trigger data, and activate the respective trigger data according to the detected activation scheme. If activated, each one of the plurality of trigger data respectively enables a corresponding operation to be performed at the device. Each one of the plurality of activation data respectively correspond to each one of the plurality of trigger data.

### BRIEF DESCRIPTION OF THE DRAWINGS

FIG. 1 depicts an apparatus that includes an RF front end and that may be adapted according to certain aspects disclosed herein.

FIG. 2 is a block diagram illustrating a device that employs an RFFE bus to couple various front end devices.

FIG. 3 is a diagram that illustrates an example of a system architecture for an apparatus employing a data link between IC devices according to certain aspects disclosed herein.

FIG. 4 is a diagram of an RFFE register space.

FIG. 5 is a diagram illustrating an example of a generalized triggering architecture for a device according to some aspects of the present disclosure.

FIG. 6 is a diagram illustrating another example of a generalized triggering architecture for a device according to some aspects of the present disclosure.

FIG. 7 is a diagram illustrating an example trigger activation (TA) countdown register bit definition and other example register configurations.

FIG. 8 is a flow chart of a method performed at a device for activating a trigger according to some aspects of the present disclosure.

FIG. 9 is a flow chart of a method for activating a trigger according to some aspects of the present disclosure.

FIG. 10 is a diagram illustrating an example of a hardware implementation for an apparatus and employing a processing circuit to support operations related to one or more aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Example of an Apparatus with Multiple IC Device Subcomponents

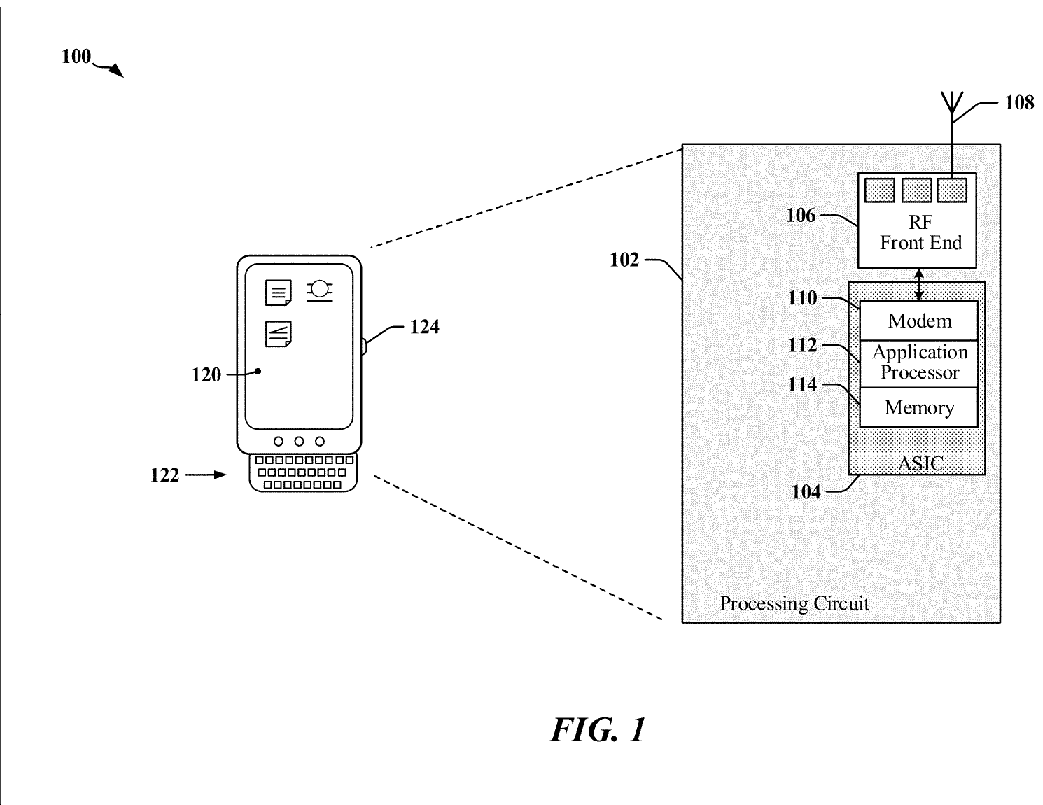

Certain aspects of the invention may be applicable to communications links deployed between electronic devices that include subcomponents of an apparatus such as a telephone, a mobile computing device, an appliance, automobile electronics, avionics systems, etc. FIG. 1 depicts an apparatus 100 that may employ a communication link between IC devices. In one example, the apparatus 100 may be a communication device. The apparatus 100 may include a processing circuit having two or more IC devices 104, 106 that may be coupled using a first communication link. One IC device may include an RF front end 106 that may be operated to enable the apparatus to communicate through one or more transceivers 108 with a radio access network, a core access network, the Internet and/or another network. The RF front end 106 may include a plurality of devices coupled by a second communication link, which may include an RFFE bus.

The processing circuit 102 may include one or more application-specific IC (ASIC) devices. An IC device 104 may include and/or be coupled to one or more processing devices 112, logic circuits, one or more modems 110, and processor readable storage such as a memory device 114 that may maintain one or more instructions and data that may be executed by a processor on the processing circuit 102. The processing circuit 102 may be controlled by one or more of an operating system and an application programming interface (API) layer that supports and enables execution of software modules residing in storage media. The memory device 114 may include read-only memory (ROM) or random-access memory (RAM), electrically erasable programmable ROM (EEPROM), flash cards, or any memory device that can be used in processing systems and computing platforms. The processing circuit 102 may include or have access to a local database or parameter storage that can maintain operational parameters and other information used to configure and operate apparatus 100. The local database may be implemented using one or more of a database module, flash memory, magnetic media, EEPROM, optical media, tape, soft or hard disk, or the like. The processing circuit may also be operably coupled to external devices such as the transceivers 108, a display 120, operator controls, such as a button 124 and/or an integrated or external keypad 122, among other components.

### Overview of the RFFE Bus

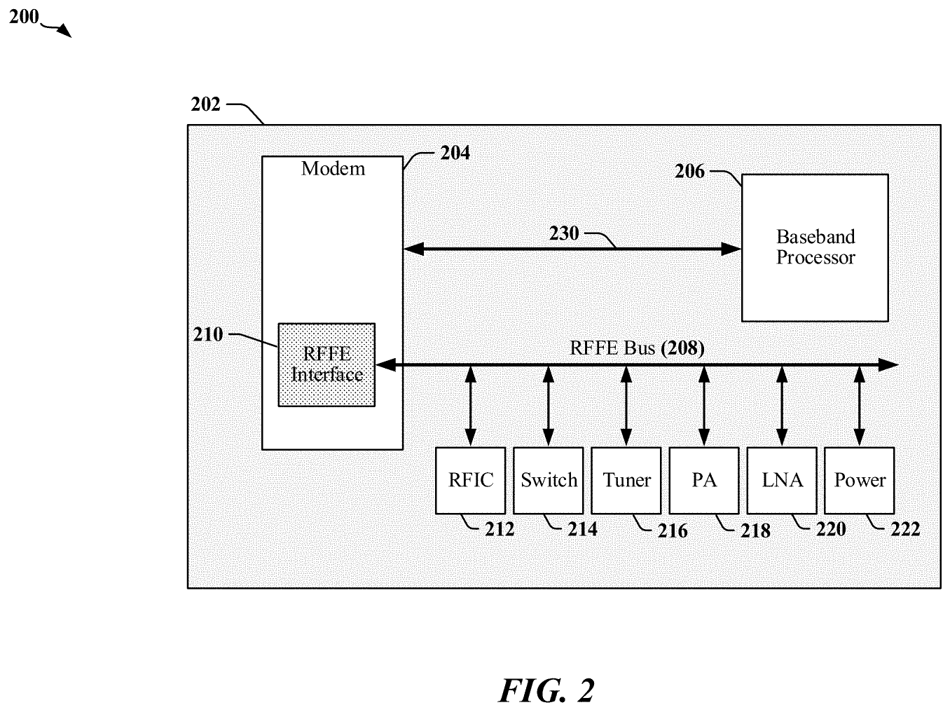

FIG. 2 is a block diagram 200 illustrating an example of a device 202 that employs an RFFE bus 208 to couple various front end devices 212, 214, 216, 218, 220, and 222. Although the device 202 will be described with respect to an RFFE interface, it is contemplated that the device 202 may also apply to a system power management interface (SPMI) and other multi-point serial interfaces. A modem 204 may also be coupled to the RFFE bus 208. The modem may communicate with a baseband processor 206. The illustrated device 202 may be embodied in one or more of a mobile device, a mobile telephone, a mobile computing system, a telephone, a notebook computer, a tablet computing device, a media player, a gaming device, a wearable computing and/or communications device, an appliance, or the like. In various examples, the device 202 may be implemented with one or more baseband processors 206, modems 204, multiple communications links 208, 230, and various other buses, devices and/or different functionalities.

In the example illustrated in FIG. 2, the RFFE bus 208 may be coupled to an RF integrated circuit (RFIC) 212, which may include one or more controllers, and/or processors that configure and control certain aspects of the RF front end. The RFFE bus 208 may couple the RFIC 212 to a switch 214, an RF tuner 216, a power amplifier (PA) 218, a low noise amplifier (LNA) 220, and a power management module 222.

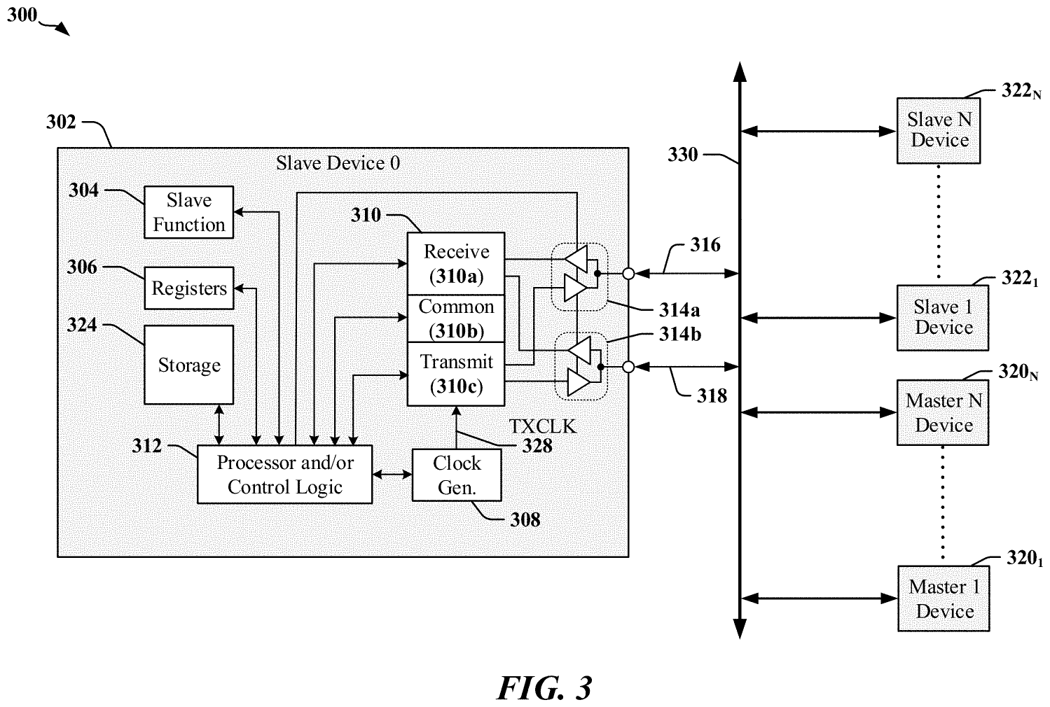

FIG. 3 is a block schematic diagram illustrating an example of an architecture for a device 300 that may employ an RFFE bus 330 to connect bus master devices 320₁-320_{N} and slave devices 302 and 322₁-322_{N}. The RFFE bus 330 may be configured according to application needs, and access to multiple buses 330 may be provided to certain of the devices 320₁-320_{N}, 302, and 322₁-322_{N}. In operation, one of the bus master devices 320₁-320_{N} may gain control of the bus and transmit a slave identifier (slave address) to identify one of the slave devices 302 and 322₁-322_{N} to engage in a communication transaction. Bus master devices 320₁-320_{N} may read data and/or status from slave devices 302 and 322₁-322_{N}, and may write data to memory or may configure the slave devices 302 and 322₁-322_{N}. Configuration may involve writing to one or more registers or other storage on the slave devices 302 and 322₁-322_{N}.

In the example illustrated in FIG. 3, a first slave device 302 coupled to the RFFE bus 330 may respond to one or more bus master devices 320₁-320_{N}, which may read data from, or write data to the first slave device 302. In one example, the first slave device 302 may include or control a power amplifier (see the PA 218 in FIG. 2), and one or more bus master devices 320₁-320_{N} may from time-to-time configure a gain setting at the first slave device 302.

The first slave device 302 may include configuration registers 306 and/or other storage devices 324, a processing circuit and/or control logic 312, a transceiver 310 and a number of line driver/receiver circuits 314a, 314b as needed to couple the first slave device 302 to the RFFE bus 330 (e.g., via a serial clock line 316 and a serial data line 318). The processing circuit and/or control logic 312 may include a processor such as a state machine, sequencer, signal processor or general-purpose processor. The transceiver 310 may include one or more receivers 310a, one or more transmitters 310c and certain common circuits 310b, including timing, logic and storage circuits and/or devices. In some instances, the transceiver 310 may include encoders and decoders, clock and data recovery circuits, and the like. A transmit clock (TXCLK) signal 328 may be provided to the transmitter 310c, where the TXCLK signal 328 can be used to determine data transmission rates.

The RFFE bus 330 is typically implemented as a serial bus in which data is converted from parallel to serial form by a transmitter, which transmits the encoded data as a serial bitstream. A receiver processes the received serial bitstream using a serial-to-parallel convertor to deserialize the data.

### Exemplary Operating Environment for Triggering Devices on an RFFE Bus

Certain aspects disclosed herein relate to triggering logical devices on an RFFE bus. Although novel triggering solutions will be described herein with respect to an RFFE bus/interface, it is contemplated that such solutions may also apply to a system power management interface (SPMI) and other multi-point serial interfaces.

A baseline RFFE bus speed may be limiting when triggering multiple devices on a bus. Triggers associated with each action per RF control path causes bus congestion when there are multiple RF control paths active. Moreover, module designs due to area savings imply that multiple receive paths/transmit paths may be concurrently operational on the same module, which may require multiple triggers that cause congestion. A problem occurs with some modules/circuits in that the modules/circuits process a large number of trigger write commands to enable configuration changes. The problem worsens when a large number of devices covering a large number of RF bands communicate on an RFFE bus. In such a case, the number of critical trigger write commands processed tend to grow with concurrency additions.

A previous triggering solution associated triggers with dynamic configuration capability. However, such solution required the sending of a command after trigger-related data was loaded into shadow registers. Hence, because sending the command involves sending an additional datagram on the RFFE bus, the previous triggering solution added latency to a triggering operation.

Aspects of the present disclosure improve upon the previous solution by providing a number of novel techniques for improving triggering operations. The improvements involve, for example, contiguity of trigger-shadow and trigger-activation registers to minimize latency, a provision to include local clock-based auto-triggering, correlator-based trigger signal detection, a provision to enable asynchronous-interrupt (in-band interrupt (IBI)) during a countdown timer duration (when a clock is incrementing down), and a provision to compensate for a missed clock-cycle during start sequence code (SSC) signaling by using a local trigger counter for better trigger timing accuracy.

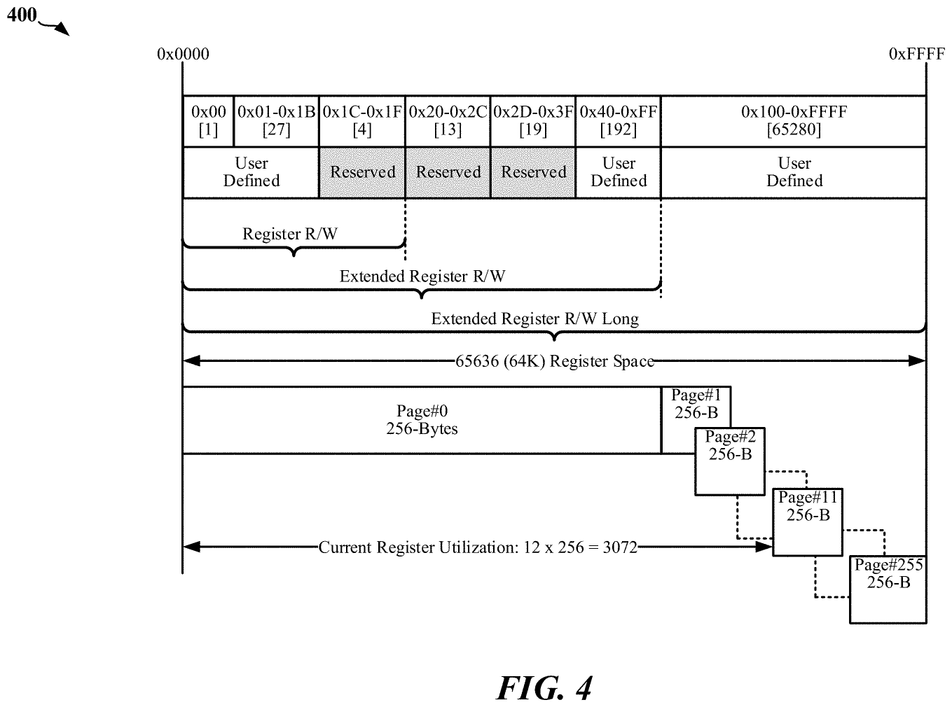

FIG. 4 is a diagram of an RFFE register space 400. The RFFE register space 400 may extend from register 0x0000 to register 0xFFFF in hexadecimal.

An association of commands in terms of register space accessibility is shown in FIG. 4. The reach of an extended register operation may be limited to the space between the 0x00 register and the 0xFF register. However, a complex RFFE slave may contain multiple pages (each having 0x00 to 0xFF 1-byte locations) within the 64K register space, and therefore, enable extended register operation to access the entire 64K register space and reduce bus latency. To achieve this, the 64K register space may be segmented into 256 pages (pages 0x00 to 0xFF), each containing 256 register locations. An 8-bit register address in a datagram combined with a page address allows any register access within the 64K space.

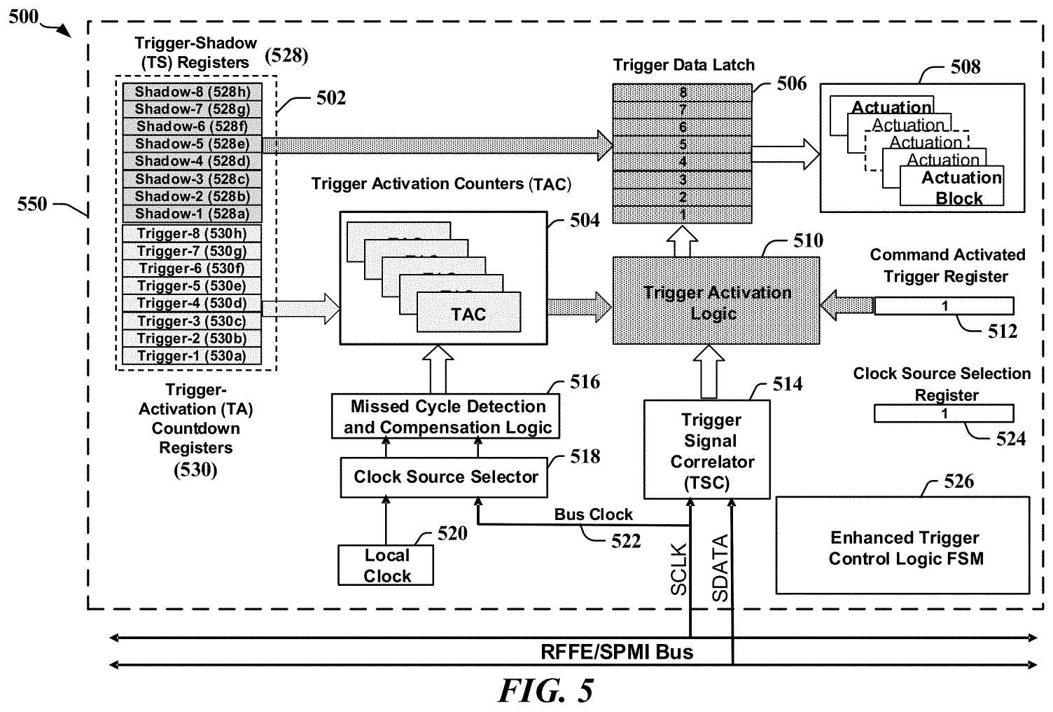

FIG. 5 is a diagram illustrating an example of a generalized triggering architecture 500 for a device 550 according to some aspects of the present disclosure. The example illustrates one register mapping that may be employed in some implementations. In other implementations, different register mappings may be used based on application requirements and/or other aspects of the architecture 500. In one example, a different register mapping may be used to reduce trigger data transmission latency in general, and/or to optimize transmission latency associated with one or more registers.

The architecture 500 may include a contiguous register region 502 of trigger-shadow (TS) registers 528 and trigger-activation (TA) countdown registers 530, trigger activation counters (TAC) 504, trigger data latches 506, actuation blocks 508, trigger activation logic 510, a command activated trigger register 512, a trigger signal correlator (TSC) 514, and a missed cycle detection and compensation logic 516. The architecture 500 may further include a clock source selector 518 that selects between a local clock 520 and a bus clock 522. The bus clock 522 may be a clock of an RFFE, SPMI, or other multi-point bus. A clock source selection register 524 may indicate to the clock source selector 518 whether to use the local clock 520 or the bus clock 522. The architecture 500 may also include an enhanced trigger control logic finite state machine (FSM) 526 that facilitates coordination between all circuits/modules of the architecture 500.

In an aspect, the device 550 may be coupled to the RFFE bus along with multiple other devices. The actuation blocks 508 may be different types of elements that the device 550 may want to trigger (or activate) for a particular type of action. For example, a power amplifier (PA) or a low-noise amplifier (LNA) may correspond to multiple actuation blocks. The actuation blocks may be in one device or spread over multiple physical devices outside of the device 550. As such, to trigger/activate a particular action, all of the actuation blocks should be synchronized and activated at the same time. To achieve this, a group of registers (trigger-shadow registers) may be loaded with trigger-related data/content. For example, one or more datagrams may be sent to load the trigger-shadow registers with the desired trigger-related data. Once the trigger-related data is loaded, the content remains in the trigger-shadow registers until the data is actually moved out of the trigger-shadow registers and loaded into the actuation blocks. In order to move the data out of the trigger-shadow registers, an additional trigger command needs to be sent to indicate which trigger-related data is to be activated. As such, there may essentially be two steps to an overall trigger event. During a first step, trigger-related data is supplied via one or more datagrams. During a second step, another batch of information is supplied to indicate which trigger-related data is to activate.

The second step of indicating which trigger-related data to activate involves sending another datagram. However, sending another datagram (e.g., on an RFFE bus or any other type of multi-point bus) increases latency. In case of RFFE, a datagram includes a start sequence code (SSC), followed by a slave address, a command code, and a register address identifying to where the activating information is going. Only after sending all of such information via the datagram will a device be able to activate the trigger-related data. Notably, a minimum number of bits needed to send a datagram to activate the trigger-related data may range from 25 to 34 bits (or clock cycles) for RFFE. The minimum number of bits may be more if multiple bytes of data are involved, such as for configurable triggers (e.g., a RFFE trigger extended by an additional 15 triggers). Accordingly, two bytes of trigger activation-related data may have to be sent, and therefore, sending information indicating which trigger-related data should activate requires a number of clock cycles. Such factor may be problematic with respect to triggers (e.g., in 5G use cases) that may require an actuation time of less than 25 clock cycles (or bits) after the trigger-related data is loaded into the trigger-shadow registers.

Aspects of the present disclosure address the previous problems by loading trigger-related data into the trigger-shadow registers, indicating which trigger-related data to activate, and loading the trigger-related data into the actuation blocks for a particular objective in a manner that reduces latency.

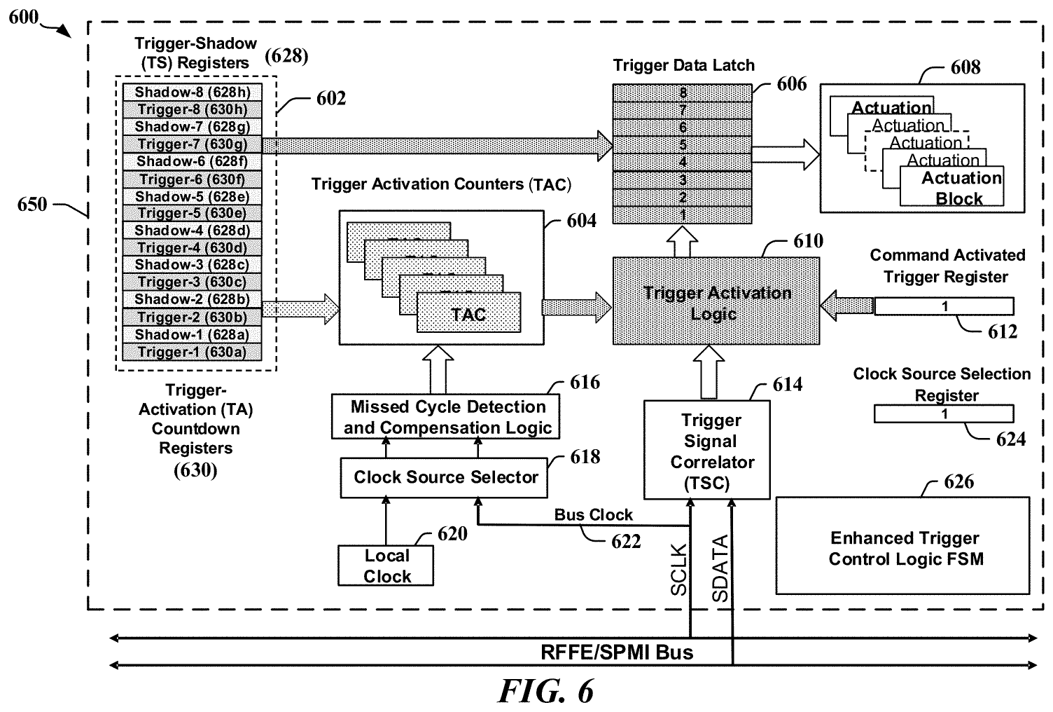

In an aspect of the disclosure, the trigger-shadow (TS) registers 528 (e.g., Shadow-1 register 528a to Shadow-8 register 528h) and the trigger-activation (TA) countdown registers 530 (e.g., Trigger-1 register 530a to Trigger-8 register 530h) reside in a contiguous region 502 of a register space so as to be able to load the TS registers 528 and the TA countdown registers 530 using one datagram (or one transaction) or a minimal number of datagrams (or a minimal number of transactions), and consequently reduce latency. Although only 8 triggers are depicted in FIG. 5 (8 TS registers 528), aspects of the present disclosure may support up to 15 or more triggers. Moreover, although the TS registers 528 and the TA countdown registers 530 are shown to be distributed in a serial manner with each other in the region 502, the TS registers 528 and the TA countdown registers 530 may be distributed in an alternating (or interleaved) manner (e.g., a first TA countdown register, followed by a first TS register, followed by a second TA countdown register, followed by a second TS register, etc.), as described with respect to FIG. 6 below.

At the moment the TS registers 528 are loaded with trigger-related data, the TA countdown registers 530 are also loaded with activation data. In an aspect, the purpose of a TA countdown register is to hold a countdown value for a corresponding trigger-related data. The countdown value may be loaded into a trigger activation counter (TAC) 504. Right after the countdown value is loaded into the TAC 504, countdown activity commences. When the count reaches 0, a corresponding trigger (the data from a corresponding TS register 528 that is already waiting to be loaded via a trigger data latch 506 into a trigger activation element) is loaded into the trigger activation element (actuation block 508). Such an operation minimizes latency by preventing the situation where the TS registers 528 are first loaded using one datagram and then corresponding TA countdown registers 530 are loaded using another datagram. As more datagrams are utilized in an RFFE operation, latency is increased. Therefore, aspects of the present disclosure provide that the two bands of registers (TS registers 528 and TA countdown registers 530) be located in a contiguous register space to reduce latency by virtue of the registers being in one contiguous region.

In an aspect of the disclosure, one or more configuration registers (e.g., clock source selection register 524) are provided to indicate utilization of an RFFE bus clock 522 or a local clock 520 for the trigger activation counters (TAC) 504. The availability of the local clock source 520 and the option to select such source for a trigger counter operation may eliminate the need for the RFFE bus clock 522, and therefore reduce power consumption. The one or more configuration registers may indicate whether the TAC 504 is clocked by a rising edge, falling edge, or by both rising and falling edges. The one or more configuration registers may indicate whether the TAC 504 operates as a down-counter or up-counter. With respect to the illustrated example, the TA countdown registers 530 may be repurposed as TA count-up registers or registers reserved for up-counting may be used when the TAC 504 operates as an up-counter. The one or more configuration registers may indicate a non-zero target value that indicates the TAC 504 value at which one or more triggers are to be loaded into corresponding trigger activation elements.

RFFE slave devices may be placed into two categories based on their clock sourcing or internal clock capability. One type of RFFE slave device does not have an internal clock source available (e.g., simple antenna switch or multiplexer). Another type of RFFE slave device includes an internal clock source (e.g., internal clock oscillator). In an aspect, the device 550 may utilize its local counter (e.g., local clock 520), if available, to operate the TAC 504 for a trigger activation countdown. The device 550 may have the option of specifying (e.g. via the clock source selector 518) which clock source to use for countdown purposes. If the local clock 520 is used, the countdown occurs as the local clock runs (increments). However, if the bus clock 522 is used, the bus clock 522 must be available to the device 550. The bus clock 522 may be available to the device 550 under two circumstances.

In a first circumstance, after the TS registers 528 and the TA countdown registers 530 are loaded, a master device may further try to send information (via a datagram) to another peripheral device on the bus. The information cannot be sent to the other peripheral device without having the bus clock 522 run. Therefore, the bus will have a clock signal running during this time and the TAC 504 can utilize the already-available clock signal on the bus clock 522 for a trigger activation operation.

In another circumstance, after the TS registers 528 and the TA countdown registers 530 are loaded, the master device may not be required to send another datagram to any other peripheral device. Therefore, the bus clock 522 may not be active as the bus is in an idle condition. In an aspect, the bus clock 522 may be kept running for no other reason than to make the clock signal available to the TAC 504 for trigger activation purposes. This would be a dedicated use of the bus SCLK line. In an aspect, the bus clock 522 may be utilized for trigger activation purposes while the bus clock 522 is available for interrupt monitoring purposes.

In an aspect, a hardware correlator is provided to detect unique signaling from a host to activate trigger-related data. Activation of trigger-related data may be indicated as binary coded decimal (BCD) encoded values or pulse count encoded values. As shown in FIG. 5, a trigger signal correlator (TSC) 514 permits use of special signaling transmitted by a master device to activate time sensitive specific trigger-related data without having a local activation counter on the device 550. In an aspect, a full RFFE datagram may not be necessary to indicate which trigger-related data is to be activated. Rather, a different type of datagram, which uses less bits (or less clock cycles) to convey information as compared to the full RFFE datagram, may be utilized to indicate a trigger-related data to activate. For example, a special signature may be created using 1 clock cycle or a combination of a number of clock cycles (e.g., 3 or 4 clock cycles) on the bus data line (SDATA) to indicate to the TSC 514 which trigger-related data to activate. The TSC 514 may include hardware circuitry that looks for a specific signaling pattern, which can then be detected to lead or cause the activation of pending trigger-related data via a trigger data latch 506.

In an aspect, the clock line (SCLK) of the RFFE bus (bus clock 522) may be utilized while the RFFE bus is in an Asynchronous-Interrupt detection phase (e.g., while a master device is in an Asynchronous-Interrupt alert mode). For example, after the TS registers 528 and the TA countdown registers 530 are loaded, no data may be transmitted on the RFFE bus. However, an interrupt-monitoring phase on the bus may commence. During the interrupt-monitoring phase, the bus clock 522 will be active. As such, since the bus clock 522 is active, the bus clock 522 may be utilized to keep the TAC 504 running even when no data is being transmitted on the bus and/or the local clock 520 is not available. This may help devices (e.g., antenna switches) that do not have local clock oscillators perform triggering operations more efficiently. Such devices may make use of the active bus clock 522 during the interrupt-monitoring phase.

In an aspect, the missed cycle detection and compensation logic 516 is provided to compensate for missed clock cycles when a new datagram is issued by a host before a countdown value reaches zero. Hence, while the device 550 is configured to use the bus clock 522 for a trigger activation counter (TAC) operation, a missed cycle due to the sending of an SSC may be compensated for by using the local clock 520. This aids the counting process and increases accuracy.

For example, after the TS registers 528 and the TA countdown registers 530 are loaded, if a datagram is to be transmitted on the bus, there may be a time when the SSC is sent on the bus while there is no activity on the clock line (SCLK) (bus clock 522). Consequently, the inactivity of the bus clock 522 may cause one or two clock cycles to be missed. This, in turn, causes the TAC 504 to not run (advance) and latency to increase (especially if the local clock 520 is not available). To compensate for the missed clock cycles, the missed cycle detection and compensation logic 516 may detect a missed cycle due to the inactivity of the bus clock 522 and use the local clock 520 to offset the missed cycle. As such, the TAC 504 is able to perform a countdown more accurately and activate trigger-related data more precisely.

The clock source selection register 524 may indicate to the device 550 or the clock source selector 518 whether the local clock 520 or the bus clock 522 is to be used for trigger operations. The enhanced trigger control logic finite state machine (FSM) 526 provides coordination between all of circuits/modules of the device 550.

The TS register 528 and the TA countdown registers 530 contain trigger-related data. In an example, one actuation block of the actuation blocks 508 may correspond to a power amplifier (PA). Moreover, a gain of the PA may need to be set. Accordingly, the gain of the PA may be set according to how an 8-bit field in the actuation block corresponding to the PA is set. An 8-bit value to load into the actuation block may be retrieved from one of the TS registers 528, i.e., a TS register associated with the actuation block corresponding to the PA. In other words, the trigger-related data loaded in the TS register corresponding to the PA may be loaded into the corresponding actuation block to set the gain of the PA when the trigger-related data is activated (triggered).

In an aspect, after the TS registers 528 are loaded with trigger-related data, the command activated trigger register 512 may be loaded to cause the activation of a trigger-related data. The command activated trigger register 512 is denoted by the number “1” in FIG. 5 indicating that one register is present. Moreover, the one register has a length of 8 bits. The 8 bits may be denoted as D7, D6, D5, D4, D3, D2, D1, and D0 (not shown). Each of the 8 bits in the command activated trigger register 512 may correspond to one of eight TS registers 528. For example, after loading the TS registers 528, if the content of an eighth TS register (of the TS registers 528) denoted by the number “8” is to be activated on a corresponding actuation block 508, a D7 bit in the command activated trigger register 512 (representing the eighth TS register) may be set to allow the content of the eighth TS register to be loaded in the corresponding actuation block 508. In an aspect, an RFFE command/datagram may be transmitted to load the command activated trigger register 512.

In an aspect, the TAC 504 may be utilized to avoid having to load the command activated trigger register 512 to cause the activation of a trigger-related data. For example, the TA countdown registers 530 may be loaded with countdown values. A first TA countdown register (of the TA countdown registers 530) denoted by the number “1” corresponds to a first TS register (of the TS registers 528) denoted by the number “1”. Also, the countdown value of the first TA countdown register may be loaded into a TAC 504. If the loaded countdown value is 15, for example, the TAC 504 increments from 15 down to a value of 0 (e.g., 15 . . . 14 . . . 13 . . . , 0). At the moment the TAC 504 reaches the value of 0, the content (trigger-related data) of the first TS register will be loaded into a corresponding first trigger element of the actuation blocks 508 to activate the trigger-related data. Accordingly, the need to send a datagram to set a particular bit (e.g., D0 bit) in the command activated trigger register 512 corresponding to the first TS register in order to activate the trigger-related data may be avoided.

In an aspect, the trigger operations described herein may involve a combination of operations performed by hardware and software. For example, when the TAC 504 counts down to a value of 0, a processor may be interrupted, which then moves the content of a TS register 528 into an actuation block 508 to be activated. The processor may perform such operation with software involvement.

FIG. 6 is a diagram illustrating another example of a generalized triggering architecture 600 for a device 650 according to some aspects of the present disclosure. The example illustrates one register mapping that may be employed in some implementations. In other implementations, different register mappings may be used based on application requirements and/or other aspects of the architecture 600. In one example, a different register mapping may be used to reduce trigger data transmission latency in general, and/or to optimize transmission latency associated with one or more registers.

The architecture 600 may include a contiguous register region 602 having trigger-shadow (TS) registers 628 and trigger-activation (TA) countdown registers 630 distributed in an alternating (or interleaved) manner. Other components of the architecture 600 (e.g., trigger activation counters (TAC) 604, trigger data latches 606, actuation blocks 608, trigger activation logic 610, command activated trigger register 612, trigger signal correlator (TSC) 614, missed cycle detection and compensation logic 616, clock source selector 618, local clock 620, bus clock 622, RFFE/SPMI (or other multi-point) bus, clock source selection register 624, and enhanced trigger control logic finite state machine (FSM) 626) may be the same as, or function in the same manner as, corresponding components described with respect to FIG. 5 above. Therefore, description of such components will be omitted for brevity.

In an aspect of the disclosure, the trigger-shadow (TS) registers 628 (e.g., Shadow-1 register 628a to Shadow-8 register 628h) and the trigger-activation (TA) countdown registers 630 (e.g., Trigger-1 register 630a to Trigger-8 register 630h) reside in a contiguous region 602 of a register space so as to be able to load the TS registers 628 and the TA countdown registers 630 using one datagram (or one transaction) or a minimal number of datagrams (or a minimal number of transactions), and consequently reduce latency. Although only 8 triggers are depicted in FIG. 6 (8 TS registers 628a, 628b, 628c, 628d, 628e, 628f, 628g, and 628h), aspects of the present disclosure may support up to 15 or more triggers. Moreover, the TS registers 628 and the TA countdown registers 630 may be distributed in an alternating/interleaved manner with each other in the region 602. For example, a first TA countdown register (Trigger-1) 630a may be followed by a first TS register (Shadow-1) 628a, followed by a second TA countdown register (Trigger-2) 630b, followed by a second TS register (Shadow-2) 628b, etc. This type of distribution allows for use of a single smaller datagram to load the TS registers and the TA countdown registers if a specific use case demands a specific shadow register loading and trigger-activation register setting. According to certain aspects, the TAC 604 may operate as an up-counter, and/or one or more configuration registers may indicate a non-zero target value that indicates the value of the TAC 604 to be reached before one or more triggers are loaded into corresponding trigger activation elements. The one or more configuration registers may indicate whether the TAC 604 counts rising edges, falling edges, or both rising and falling edges.

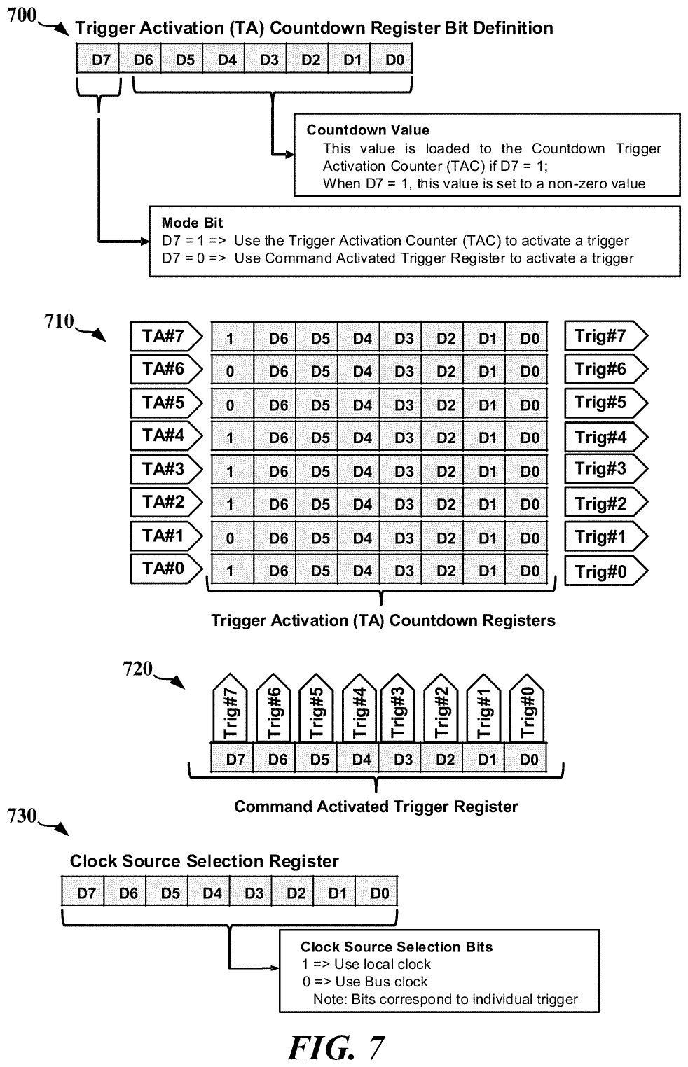

FIG. 7 is a diagram illustrating an example trigger activation (TA) countdown register bit definition 700 and other example register configurations. In the example, the countdown register bit definition 700 relates to an 8-bit countdown register, although the countdown register may have any number of bits. The example TA countdown register bit definition 700 may define a bit configuration of a TA countdown register 530 of FIG. 5 or a TA countdown register 630 of FIG. 6. As shown, a first lower 7 bits (e.g., bits D6, D5, D4, D3, D2, D1, and D0) may indicate a countdown value. A last bit (e.g., bit D7) may indicate a mode. For example, when the mode bit D7=1, use of a countdown trigger activation counter (TAC 504/604) to activate a trigger is indicated. When the mode bit D7=0, use of a datagram/command trigger register (e.g., command activated trigger register 720 or command activated trigger register 512/612) or a correlated signal (e.g., via TSC 514/614) to activate a trigger is indicated. The countdown value provided by the bits D6 to D0 may be loaded to the countdown trigger activation counter (TAC 504/604) when the mode bit D7=1. Moreover, when the mode bit D7=1, the value provided by the bits D6 to D0 is a non-zero value.

Optionally, 6 bits in the example TA countdown register bit definition 700 may be used to indicate the countdown value (or a number of clock cycles for the countdown). The 6 bits may be used to indicate a clock source (e.g., local clock selection or bus clock selection). Using the 6 bits, a countdown value of 64 may be provided, which is a large enough value of clock cycles such that an additional register (e.g., clock source selection register 730 or clock source selection register 524/624) for specifying the clock source may no longer be needed.

TA countdown registers 710 provide an example configuration of the TA countdown registers 530/630. In the example, 8 TA countdown registers (TA#0 to TA#7) respectively correspond to 8 different configurable triggers (Trig#0 to Trig#7), which correspond to the trigger-related data respectively loaded in the 8 TS registers 528/628. When a mode bit (e.g., bit D7) is equal to 1 in a TA countdown register, for example, a countdown counter (e.g., TAC 504/604) may be used to activate a trigger.

When the mode bit (e.g., bit D7) is equal to 0 in the TA countdown register, for example, a datagram (e.g., sent to command activated trigger register 720 or command activated trigger register 512/612), or a correlated signal (e.g., via TSC 514/614), may be used to activate a trigger (trigger-related data). In the example command activated trigger register 720, the bits D7 to D0 respectively correspond to the 8 different configurable triggers (Trig#7 to Trig#0). Accordingly, a datagram may be sent to set any of the bits D7 to D0 in the command activated trigger register 720 to activate a corresponding trigger (trigger-related data).

In an aspect, the example configuration of the TA countdown registers 710 illustrates a mixed trigger activation scheme, where some triggers may operate using a countdown trigger method and other triggers may operate using a datagram/command-activated method. As shown, triggers Trig#0, Trig#2, Trig#3, Trig#4 and Trig#7 are activated via a countdown counter (e.g., TAC 504/604) since the mode bit (e.g., bit D7) in respectively corresponding TA countdown registers TA#0, TA #2, TA #3, TA #4 and TA #7 has a value of 1. Furthermore, triggers Trig#1, Trig#5, and Trig#6 are activated via a datagram/command (e.g., command activated trigger register or correlated signal) since the mode bit (e.g., bit D7) in respectively corresponding TA countdown registers TA#1, TA#5, and TA#6 has a value of 0.

A clock source selection register 730 may include bits for indicating a clock source selection. In an aspect, the bits D7 to D0 respectively correspond to the 8 different configurable triggers (Trig#7 to Trig#0). Accordingly, a datagram may be sent to set any of the bits D7 to D0 in the clock source selection register 730 to indicate which clock source to use for a corresponding trigger. In one example, a bit may be set to a value of 1 to indicate use of a local clock (e.g., local clock 520/620) for a particular trigger and set to a value of 0 to indicate use of a bus clock (e.g., bus clock 522/622) for the particular trigger. In another example, a bit may be set to a value of 0 to indicate use of a local clock (e.g., local clock 520/620) for a particular trigger and set to a value of 1 to indicate use of a bus clock (e.g., bus clock 522/622) for the particular trigger. In an aspect, if a trigger-related data is common across multiple physical devices on the bus, then the local clock may not be used. This is to avoid trigger timing differences due to clock frequency deviations between devices.

### Examples of Methods and Processing Circuit

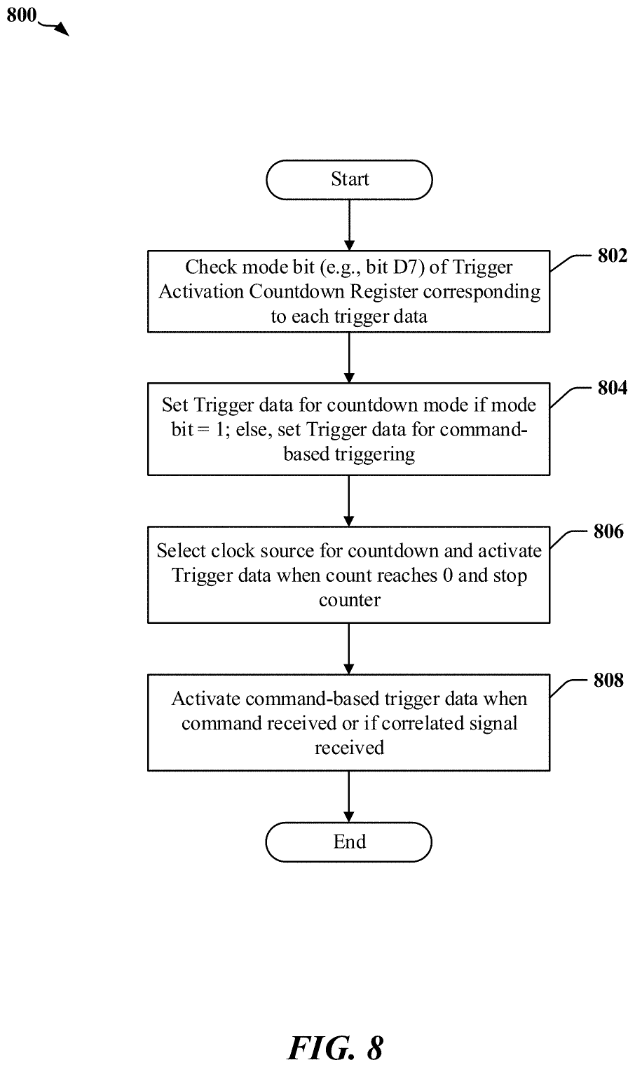

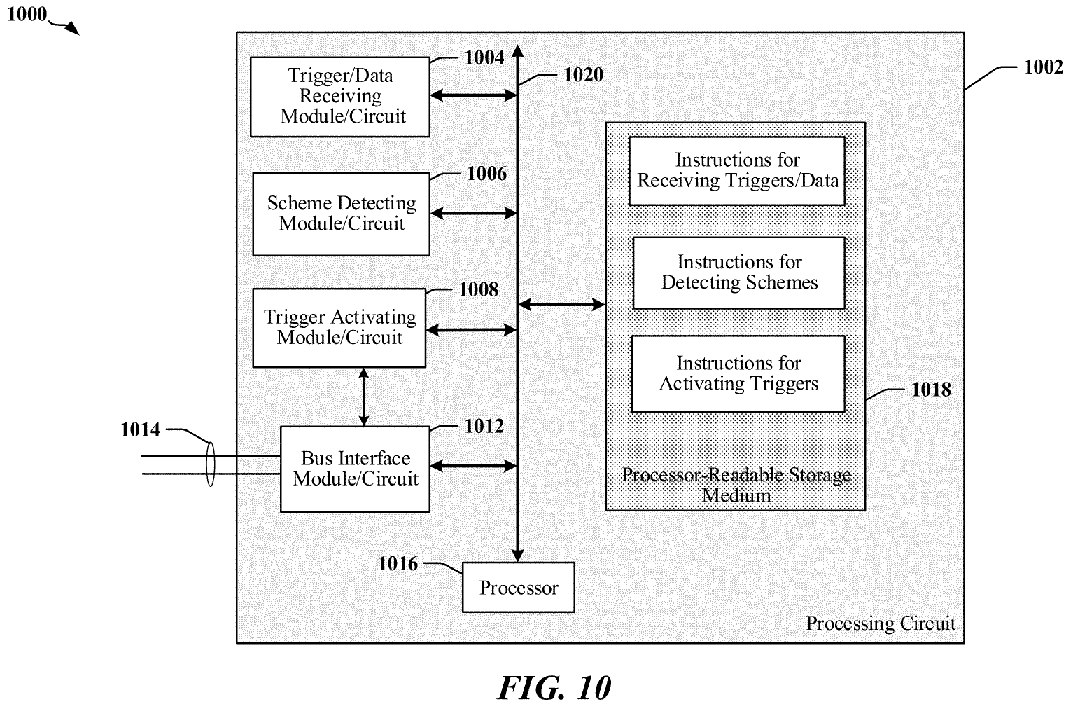

FIG. 8 is a flow chart 800 of a method performed at a device for activating trigger-related data (trigger data) according to some aspects of the present disclosure. The method may be performed at a device (e.g., apparatus 1000 of FIG. 10).

At block 802, the device may check a mode bit (e.g., bit D7) of a trigger activation countdown register (e.g., TA countdown register 710) corresponding to each trigger data.

At block 804, the device may set a trigger data to be activated according to a countdown mode if the mode bit in a corresponding trigger activation countdown register is equal to 1 (e.g., bit D7=1). Moreover, the device may set a trigger data to be activated according to command-based triggering if the mode bit in a corresponding trigger activation countdown register is equal to 0 (e.g., bit D7=0).

At block 806, the device may select a clock source (e.g., local clock 520/620 or bus clock 522/622) for any trigger data set to be activated according to the countdown mode. A counter then operates to start a count based on the clock source. The trigger data activate when the count reaches a value of 0. The counter then stops operating.

At block 808, the device may activate any trigger data set to be activated according to command-based triggering when a command or a correlated signal is received.

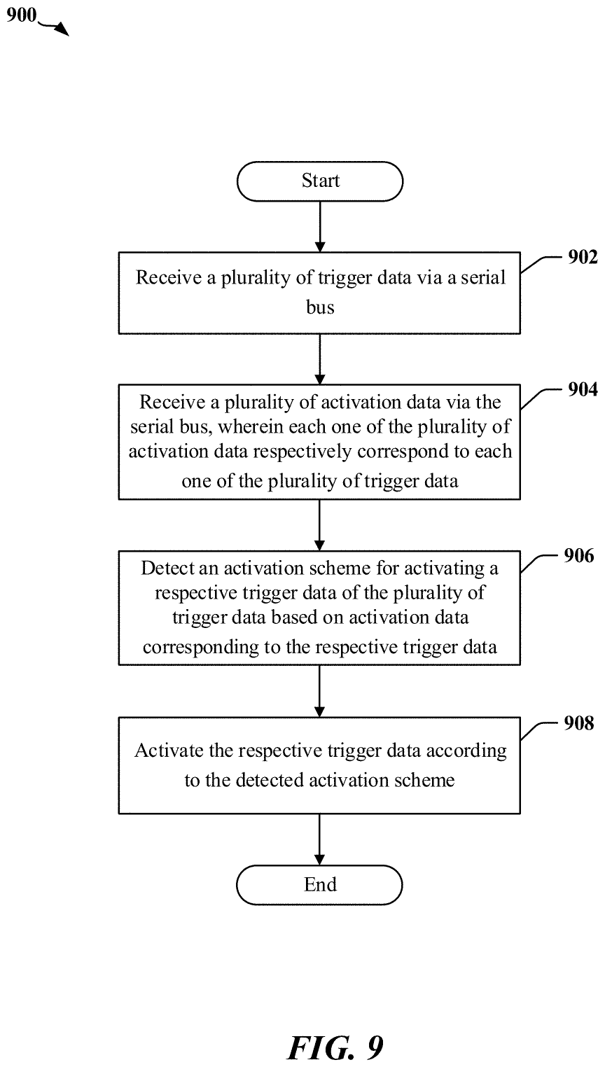

FIG. 9 is a flow chart 900 of a method for activating trigger data according to some aspects of the present disclosure. The method may be performed at a device (e.g., apparatus 1000 of FIG. 10).

The device may receive a plurality of trigger-related data (trigger data) via a serial bus 902. For example, the received plurality of trigger data may be stored in trigger-shadow (TS) registers 528/628. If activated, each one of the plurality of trigger data may respectively cause/enable a corresponding operation (e.g., setting a gain of a power amplifier) to be performed at the device.

The device may also receive a plurality of activation data via the serial bus 904. For example, the received plurality of activation data may be information stored in trigger-activation (TA) countdown registers 530/630. Each one of the plurality of activation data respectively correspond to each one of the plurality of trigger data.

In an aspect, the plurality of trigger data and the plurality of activation data are received via a single datagram (or via a single transaction). Moreover, the received plurality of trigger data and the received plurality of activation data may be stored in contiguous register locations of a register space (e.g., contiguous register region 502). In a further aspect, each one of the received plurality of trigger data can be stored in an alternating (or interleaved) manner with a corresponding one of the received plurality of activation data in the register space.

The device may detect an activation scheme for activating a respective trigger data of the plurality of trigger data based on activation data corresponding to the respective trigger data 906. Thereafter, the device may activate the respective trigger data according to the detected activation scheme 908. In an example, the device may activate the trigger data to cause/enable a particular type of device action (e.g., setting a gain of a power amplifier).

In an aspect, the device detects the activation scheme by reading a mode bit (e.g., bit D7) of the corresponding activation data. If the mode bit is a first value (e.g., 1), the device detects that the respective trigger data is to be activated according to a counter. If the mode bit is a second value (e.g., 0), the device detects that the respective trigger data is to be activated according to a command.

In an aspect, if the mode bit is the first value, the device may activate the respective trigger data in a particular manner. For example, the device may retrieve a first counter value from the corresponding activation data, select a clock source for the counter, operate the counter based on the clock source beginning from a second counter value, and activate the respective trigger data when the counter reaches a third counter value. The clock source may be a local clock or a bus clock. In an aspect, the clock source is selected based on a received datagram addressed to a clock source selection register. In one example, the first counter value may be zero. The counter may be a countdown counter and the third counter value may be zero. In another example, the first counter value may be nonzero. The counter may be configured to count up and the second counter value may be zero. In another example, the first counter value may be nonzero and both the second and third counter values may be nonzero.

In an aspect, the type of edge that causes the counter to count up or count down may be configured using a register value. In one example, the counter may count rising edges in the clock source. In another example, the counter may count falling edges in the clock source. In another example, the counter may count both rising and falling edges in the clock source.

In an aspect, if the clock source is the bus clock, the device may compensate for a missed bus clock cycle while operating the counter by using the local clock. Moreover, the device may use the bus clock while operating the counter when the serial bus is an interrupt-monitoring phase.

In an aspect, if the mode bit is the second value, the device may activate the respective trigger data by first receiving a trigger command for activating the respective trigger data. The trigger command may be received via a datagram addressed to a command activated command register or a correlated signal from the serial bus (e.g., via a trigger signal correlator (TSC) 514). Thereafter, the device may activate the respective trigger based on the trigger command.

FIG. 10 is a diagram illustrating an example of a hardware implementation for an apparatus 1000 employing a processing circuit 1002 to support operations related to one or more aspects of the disclosure (e.g., aspects related to the methods of FIGS. 8 and 9 described above). The processing circuit typically has a processor 1016 that may include one or more of a microprocessor, microcontroller, digital signal processor, a sequencer and a state machine. The processing circuit 1002 may be implemented with a bus architecture, represented generally by the bus 1020. The bus 1020 may include any number of interconnecting buses and bridges depending on the specific application of the processing circuit 1002 and the overall design constraints. The bus 1020 links together various circuits including one or more processors and/or hardware modules, represented by the processor 1016, the modules or circuits 1004, 1006, 1008, line interface circuits 1012 (serial bus interface) configurable to communicate over connectors or wires 1014, and the computer-readable storage medium 1018 (processor-readable storage medium). The bus 1020 may also link various other circuits such as timing sources, peripherals, voltage regulators, and power management circuits, which are well known in the art, and therefore, will not be described any further.

The processor 1016 is responsible for general processing, including the execution of code and/or one or more instructions stored on the computer-readable storage medium 1018. The code/instructions, when executed by at least one processor (e.g., the processor 1016), causes the processing circuit 1002 to perform the various functions described supra for any particular apparatus. The computer-readable storage medium may also be used for storing data that is manipulated by the processor 1016 when executing software, including data decoded from symbols transmitted over the connectors or wires 1014, which may be configured as data lanes and clock lanes. The processing circuit 1002 further includes at least one of the modules/circuits 1004, 1006, and 1008. The modules/circuits 1004, 1006, and 1008 may be software modules running in the processor 1016, resident/stored in the computer-readable storage medium 1018, one or more hardware modules coupled to the processor 1016, or some combination thereof. The modules/circuits 1004, 1006, and/or 1008 may include microcontroller instructions, state machine configuration parameters, or some combination thereof.

In one configuration, the apparatus 1000 includes a trigger/data receiving module and/or circuit 1004 (means for receiving) that is configured to receive, through an interface 1012, a plurality of trigger data and a plurality of activation data via a serial bus, wherein each one of the plurality of activation data respectively correspond to each one of the plurality of trigger data. The apparatus 1000 further includes a scheme detecting module and/or circuit 1006 (means for detecting) that is configured to detect an activation scheme for activating a respective trigger data of the plurality of trigger data based on activation data corresponding to the respective trigger data. The apparatus 1000 further includes a trigger activating module and/or circuit 1008 (means for activating) that is configured to activate the respective trigger data according to the detected activation scheme.

In one example, the apparatus 1000 includes a serial bus interface and a processing circuit 1002 coupled to the serial bus interface. The processing circuit 1002 may be configured to receive a plurality of trigger data via a serial bus. If activated, each one of the plurality of trigger data respectively enables a corresponding operation to be performed at the apparatus 1000. The processing circuit 1002 may be configured to receive a plurality of activation data via the serial bus. Each one of the plurality of activation data respectively corresponds to each one of the plurality of trigger data. The processing circuit 1002 may be configured to detect an activation scheme for activating a respective trigger data of the plurality of trigger data based on activation data corresponding to the respective trigger data, and activate the respective trigger data according to the detected activation scheme. The plurality of trigger data and the plurality of activation data may be received via a single datagram. The received plurality of trigger data and the received plurality of activation data may be stored in contiguous register locations of a register space. In some instances, each one of the received plurality of trigger data is stored in an alternating manner with a corresponding one of the received plurality of activation data in the register space.

The processing circuit 1002 may be configured to read a mode bit of the corresponding activation data, detect that the respective trigger data is to be activated according to a countdown if the mode bit is a first value, and detect that the respective trigger data is to be activated according to a command if the mode bit is a second value. If the mode bit is the first value, the processing circuit 1002 is configured to retrieve a countdown value from the corresponding activation data, select a clock source for the countdown, operate the countdown based on the clock source beginning from the countdown value, and activate the respective trigger data when the countdown reaches a value of 0. The clock source may be selected based on a received datagram addressed to a clock source selection register. In some instances, the clock source is a local clock or a bus clock. If the clock source is the bus clock, the processing circuit 1002 is configured to at least one of compensate for a missed bus clock cycle using the local clock, or use the bus clock when the serial bus is an interrupt-monitoring phase. If the mode bit is the second value, the processing circuit 1002 is configured to receive a trigger command for activating the respective trigger data via at least one of a datagram addressed to a command activated command register, or a correlated signal from the serial bus, and to activate the respective trigger data based on the trigger command.

In one example, the computer-readable storage medium 1018 includes a processor-readable storage medium having one or more instructions which, when executed by at least one processor 1016 or state machine of the processing circuit 1002, cause the processing circuit 1002 to receive a plurality of trigger data via a serial bus, receive a plurality of activation data via the serial bus, detect an activation scheme for activating a respective trigger data of the plurality of trigger data based on activation data corresponding to the respective trigger data, and activate the respective trigger data according to the detected activation scheme. If activated, each one of the plurality of trigger data respectively enables a corresponding operation to be performed at the device. Each one of the plurality of activation data respectively corresponds to each one of the plurality of trigger data.

In some instances, the plurality of trigger data and the plurality of activation data are received via a single datagram. The received plurality of trigger data and the received plurality of activation data may be stored in contiguous register locations of a register space. Each one of the received plurality of trigger data is stored in an alternating manner with a corresponding one of the received plurality of activation data in the register space. The instructions which cause the processing circuit to detect the activation scheme include instructions which cause the processing circuit to read a mode bit of the corresponding activation data, detect that the respective trigger data is to be activated according to a countdown if the mode bit is a first value, and detect that the respective trigger data is to be activated according to a command if the mode bit is a second value. The instructions which cause the processing circuit to activate the respective trigger data include instructions which cause the processing circuit to retrieve a countdown value from the corresponding activation data, select a clock source for the countdown, operate the countdown based on the clock source beginning from the countdown value, and activate the respective trigger data when the countdown reaches a value of 0.

The clock source may be selected based on a received datagram addressed to a clock source selection register. The clock source can be a local clock or a bus clock. The instructions which cause the processing circuit to operate the countdown include instructions which, if the clock source is the bus clock, cause the processing circuit to compensate for a missed bus clock cycle using the local clock, or use the bus clock when the serial bus is an interrupt-monitoring phase. The instructions which cause the processing circuit to activate the respective trigger data include instructions which, if the mode bit is the second value, cause the processing circuit to receive a trigger command for activating the respective trigger data via at least one of a datagram addressed to a command activated command register or a correlated signal from the serial bus, and activate the respective trigger data based on the trigger command.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed at a device for activating trigger data, comprising:
receiving a plurality of trigger data via a serial bus, wherein, if activated, each one of the plurality of trigger data respectively enables a corresponding operation to be performed at the device;
receiving a plurality of activation data via the serial bus, wherein each one of the plurality of activation data respectively corresponds to each one of the plurality of trigger data;
detecting an activation scheme for activating a respective trigger data of the plurality of trigger data based on activation data corresponding to the respective trigger data; and
activating the respective trigger data according to the detected activation scheme.

2. The method of claim 1, wherein the plurality of trigger data and the plurality of activation data are received via a single datagram.

3. The method of claim 1, wherein the received plurality of trigger data and the received plurality of activation data are stored in contiguous register locations of a register space.

4. The method of claim 3, wherein each one of the received plurality of trigger data is stored in an alternating manner with a corresponding one of the received plurality of activation data in the register space.

5. The method of claim 1, wherein the detecting the activation scheme includes:
reading a mode bit of the corresponding activation data;
detecting that the respective trigger data is to be activated according to a counter if the mode bit is a first value; and
detecting that the respective trigger data is to be activated according to a command if the mode bit is a second value.

6. The method of claim 5, wherein if the mode bit is the first value, the activating the respective trigger data includes:
retrieving a first counter value from the corresponding activation data;
selecting a clock source for the counter;
operating the counter based on the clock source beginning from a second counter value; and
activating the respective trigger data when the counter reaches a third counter value,
wherein the second counter value or the third counter value comprises the first counter value.

7. The method of claim 6, wherein the clock source is selected based on a received datagram addressed to a clock source selection register.

8. The method of claim 6, wherein the clock source is a local clock or a bus clock.

9. The method of claim 8, wherein if the clock source is the bus clock, the operating the counter includes at least one of:
compensating for a missed bus clock cycle using the local clock; or
using the bus clock when the serial bus is in an interrupt-monitoring phase.

10. The method of claim 5, wherein if the mode bit is the second value, the activating the respective trigger data includes:
receiving a trigger command for activating the respective trigger data via at least one of:
a datagram addressed to a command activated command register, or
a correlated signal from the serial bus; and
activating the respective trigger data based on the trigger command.

11. A device for activating trigger data, comprising:
a serial bus interface; and
a processing circuit coupled to the serial bus interface and configured to:
receive a plurality of trigger data via a serial bus, wherein, if activated, each one of the plurality of trigger data respectively enables a corresponding operation to be performed at the device;
receive a plurality of activation data via the serial bus, wherein each one of the plurality of activation data respectively corresponds to each one of the plurality of trigger data;
detect an activation scheme for activating a respective trigger data of the plurality of trigger data based on activation data corresponding to the respective trigger data; and
activate the respective trigger data according to the detected activation scheme.

12. The device of claim 11, wherein the plurality of trigger data and the plurality of activation data are received via a single datagram.

13. The device of claim 11, wherein the received plurality of trigger data and the received plurality of activation data are stored in contiguous register locations of a register space.

14. The device of claim 13, wherein each one of the received plurality of trigger data is stored in an alternating manner with a corresponding one of the received plurality of activation data in the register space.

15. The device of claim 11, wherein the processing circuit is further configured to:
read a mode bit of the corresponding activation data;
detect that the respective trigger data is to be activated according to a counter if the mode bit is a first value; and
detect that the respective trigger data is to be activated according to a command if the mode bit is a second value.

16. The device of claim 15, wherein if the mode bit is the first value, the processing circuit is further configured to:
retrieve a first counter value from the corresponding activation data;
select a clock source for the counter;
operate the counter based on the clock source beginning from a second counter value; and
activate the respective trigger data when the counter reaches a third counter value,
wherein the second counter value or the third counter value comprises the first counter value.

17. The device of claim 16, wherein the clock source is selected based on a received datagram addressed to a clock source selection register.

18. The device of claim 16, wherein the clock source is a local clock or a bus clock.

19. The device of claim 18, wherein if the clock source is the bus clock, the processing circuit is further configured to at least one of:
compensate for a missed bus clock cycle using the local clock; or
use the bus clock when the serial bus is in an interrupt-monitoring phase.

20. The device of claim 15, wherein if the mode bit is the second value, the processing circuit is further configured to:
receive a trigger command for activating the respective trigger data via at least one of:
a datagram addressed to a command activated command register, or
a correlated signal from the serial bus; and
activate the respective trigger data based on the trigger command.

21. A device for activating trigger data, comprising:
means for receiving a plurality of trigger data via a serial bus, wherein, if activated, each one of the plurality of trigger data respectively enables a corresponding operation to be performed at the device;
means for receiving a plurality of activation data via the serial bus, wherein each one of the plurality of activation data respectively corresponds to each one of the plurality of trigger data;
means for detecting an activation scheme for activating a respective trigger data of the plurality of trigger data based on activation data corresponding to the respective trigger data; and
means for activating the respective trigger data according to the detected activation scheme.

22. A processor-readable storage medium having one or more instructions which, when executed by at least one processor or state machine of a processing circuit for activating trigger data at a device, cause the processing circuit to:
receive a plurality of trigger data via a serial bus, wherein, if activated, each one of the plurality of trigger data respectively enables a corresponding operation to be performed at the device;
receive a plurality of activation data via the serial bus, wherein each one of the plurality of activation data respectively corresponds to each one of the plurality of trigger data;
detect an activation scheme for activating a respective trigger data of the plurality of trigger data based on activation data corresponding to the respective trigger data; and
activate the respective trigger data according to the detected activation scheme.

23. The storage medium of claim 22, wherein the plurality of trigger data and the plurality of activation data are received via a single datagram.

24. The storage medium of claim 22, wherein the received plurality of trigger data and the received plurality of activation data are stored in contiguous register locations of a register space.

25. The storage medium of claim 24, wherein each one of the received plurality of trigger data is stored in an alternating manner with a corresponding one of the received plurality of activation data in the register space.

26. The storage medium of claim 22, wherein the instructions which cause the processing circuit to detect the activation scheme include instructions which cause the processing circuit to:
read a mode bit of the corresponding activation data;
detect that the respective trigger data is to be activated according to a counter if the mode bit is a first value; and
detect that the respective trigger data is to be activated according to a command if the mode bit is a second value.

27. The storage medium of claim 26, wherein the instructions which cause the processing circuit to activate the respective trigger data include instructions which, if the mode bit is the first value, cause the processing circuit to:
retrieve a first counter value from the corresponding activation data;
select a clock source for the counter;
operate the counter based on the clock source beginning from a second counter value; and
activate the respective trigger data when the counter reaches a third counter value,
wherein the second counter value or the third counter value comprises the first counter value.

28. The storage medium of claim 27, wherein the clock source is selected based on a received datagram addressed to a clock source selection register, and wherein the clock source is a local clock or a bus clock.

29. The storage medium of claim 28, wherein the instructions which cause the processing circuit to operate the counter include instructions which, if the clock source is the bus clock, cause the processing circuit to:
compensate for a missed bus clock cycle using the local clock; or
use the bus clock when the serial bus is in an interrupt-monitoring phase.

30. The storage medium of claim 26, wherein the instructions which cause the processing circuit to activate the respective trigger data include instructions which, if the mode bit is the second value, cause the processing circuit to:
receive a trigger command for activating the respective trigger data via at least one of:
a datagram addressed to a command activated command register, or
a correlated signal from the serial bus; and
activate the respective trigger data based on the trigger command.
